(19) United States
(12) Patent Application Publication
(10) Pub. No.: US 2020/0128157 A1
(43) Pub. Date: Apr. 23, 2020

(54) CAMERA DEVICE, CAMERA SYSTEM, AND PROGRAM

(71) Applicant: PANASONIC INTELLECTUAL PROPERTY MANAGEMENT CO., LTD., Osaka (JP)

(72) Inventor: Masaaki OCHI, Osaka (JP)

(21) Appl. No.: 16/605,765

(22) PCT Filed: Apr. 17, 2018
(86) PCT No.: PCT/JP2018/015819

§ 371 Date: Oct. 16, 2019

(30) Foreign Application Priority Data
Apr. 17, 2017 (JP) 2017-081599

(51) Int. Cl. H04N 5/225; H04N 5/232

(52) U.S. Cl. CPC H04N 5/2253; H04N 5/23264; H04N 5/2257; H04N 5/2254

(57) ABSTRACT

A driving unit drives a movable unit to hold an image capturing unit such that the movable unit moves relative to a fixed unit. A detection unit detects motion of at least one of the fixed unit or the movable unit. A driving control unit controls the driving unit based on a result of detection by the detection unit. A first interface outputs a video signal generated by the image capturing unit. A second interface transmits the result of detection by the detection unit to a telecommunications terminal via a communications unit. A third interface receives a drive command to have the driving unit controlled by the driving control unit from the telecommunications terminal via the communications unit.

### TECHNICAL FIELD

The present disclosure generally relates to a camera device, a camera system, and a program, and more particularly relates to a camera device, a camera system, and a program, all of which have the capability of driving a movable unit for holding an image capturing unit.

### BACKGROUND ART

A camera device (image capture device) with not only the inherent function of capturing a subject image but also various other additional functions has been proposed in the art (see, for example, Patent Literature 1).

Patent Literature 1 teaches preventing the camera device from being operated erroneously by distinguishing the operation of intentionally producing vibrations in the camera device (such as a tap operation of lightly tapping the camera device's housing) from other kinds of vibrations not intended by the user (such as vibration produced when the camera device is put on a desk). That is to say, the camera device of Patent Literature 1 has the function of starting, in response to the tap operation on the camera device with no physical switches operated, a type of processing allocated to the tap operation (such as ending a sleep mode).

The functions that a camera device has depend on the specifications of the camera device itself, and therefore, are usually fixed during the design and manufacturing stages of the camera device. That is to say, it is difficult to add various optional functions to the camera device afterward, once the specifications of the camera device have been fixed. Nevertheless, there has also been an increasing demand for adding various other functions to a camera device in order to expand the range of applications of the camera device.

### CITATION LIST

### Patent Literature

Patent Literature 1: JP 2012-146156 A

### SUMMARY OF INVENTION

In view of the foregoing background, it is therefore an object of the present disclosure to provide a camera device, a camera system, and a program, all of which are configured or designed to expand the range of applications of the camera device even without changing the specifications of the camera device itself.

A camera device according to an aspect of the present disclosure includes an image capturing unit, a movable unit, a fixed unit, a driving unit, a detection unit, a driving control unit, a communications unit, a first interface, a second interface, and a third interface. The image capturing unit includes an image sensor. The movable unit holds the image capturing unit thereon. The fixed unit holds the movable unit in such a manner as to make the movable unit movable. The driving unit drives the movable unit such that the movable unit moves relative to the fixed unit. The detection unit detects motion of at least one of the fixed unit or the movable unit. The driving control unit controls the driving unit based on a result of detection by the detection unit. The communications unit has the capability of communicating with a telecommunications terminal. The first interface outputs a video signal generated by the image capturing unit. The second interface transmits the result of detection by the detection unit to the telecommunications terminal via the communications unit. The third interface receives a drive command to have the driving unit controlled by the driving control unit from the telecommunications terminal via the communications unit.

A camera system according to another aspect of the present disclosure includes: the camera device described above; and the telecommunications terminal. The telecommunications terminal is configured to operate in conjunction with the camera device by performing, through communication with the camera device, at least one of detection processing based on the result of detection by the detection unit or generation processing of generating the drive command.

A program according to still another aspect of the present disclosure is designed to make a computer system having the capability of communicating with the camera device function as an acquisition unit and a command giving unit. The acquisition unit acquires the result of detection by the detection unit from the second interface. The command giving unit gives the drive command to the third interface.

### BRIEF DESCRIPTION OF DRAWINGS

FIG. 1 is a block diagram illustrating a configuration for a camera system according to an exemplary embodiment of the present disclosure;

FIG. 2A is a schematic representation illustrating the concept of a first specific example of the camera system;

FIG. 2B is a schematic representation illustrating the concept of a second specific example of the camera system;

FIG. 3A is a perspective view of a camera device included in the camera system;

FIG. 3B is a plan view of the camera device;

FIG. 4 is a cross-sectional view, taken along a plane X1-X1, of the camera device;

FIG. 5 is an exploded perspective view of the camera device; and

FIG. 6 is an exploded perspective view of a movable unit included in the camera device.

### DESCRIPTION OF EMBODIMENTS

(1) Overview

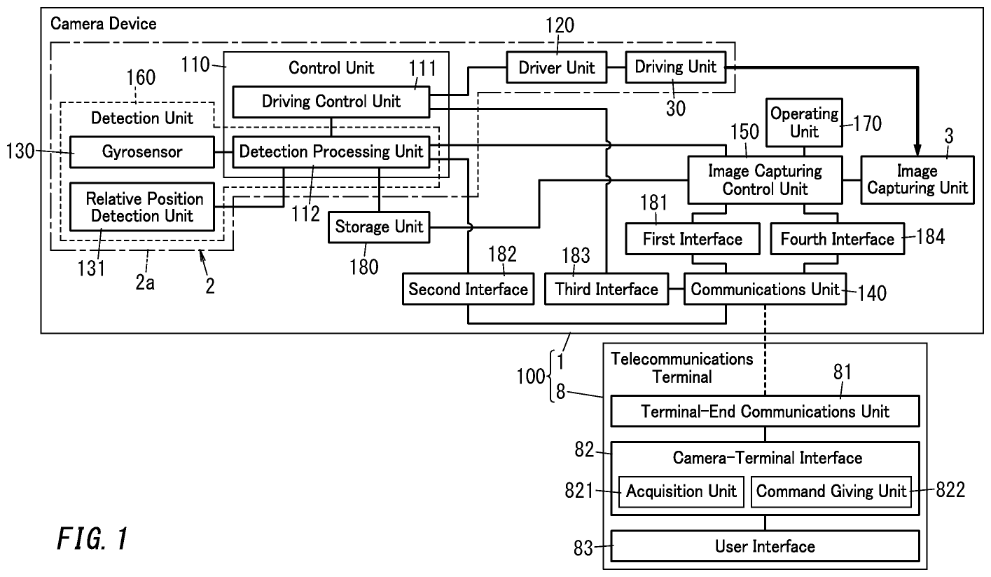

A camera system 100 according to an exemplary embodiment includes a camera device 1 and a telecommunications terminal 8 as shown in FIG. 1.

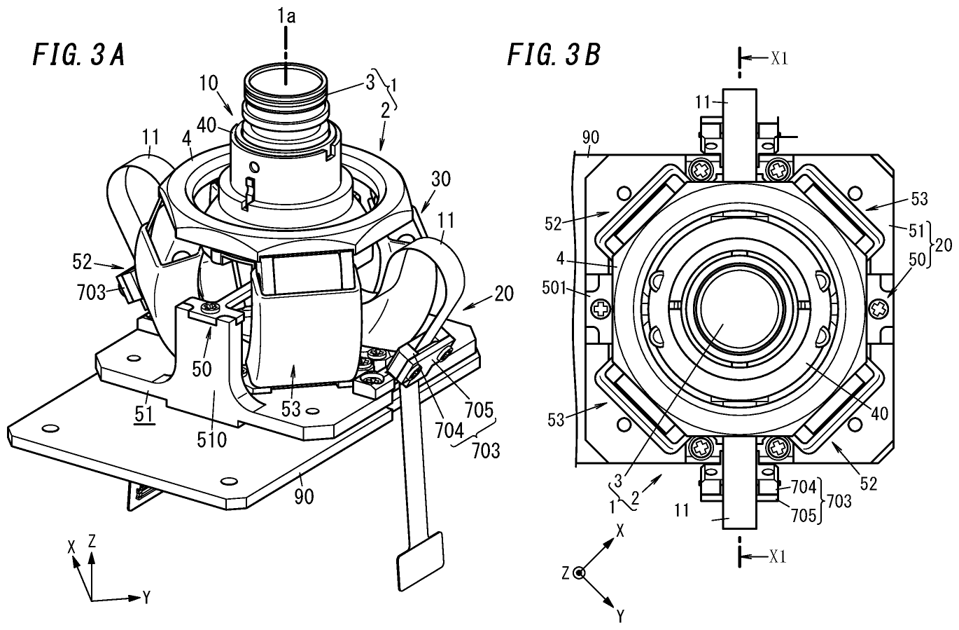

The camera device 1 includes an image capturing unit 3, and a driving unit 30 for driving a movable unit 10 (see FIG. 3A) to hold the image capturing unit 3 thereon. The camera device 1 further includes a detection unit 160 to detect movement of the camera device 1 and a driving control unit 111 for controlling the driving unit 30 based on a result of detection by the detection unit 160. This allows the camera device 1 to control the driving unit 30 based on a result of detection by the detection unit 160, thus providing a camera device with a stabilizer for reducing unwanted vibrations of the image capturing unit 3.

The camera device 1 according to this embodiment further includes a communications unit 140 for communicating with a telecommunications terminal 8 and interfaces (such as a second interface 182 and a third interface 183) allowing the camera device 1 to operate in conjunction with the telecommunications terminal 8. That is to say, the camera device 1 has not only its own inherent function of outputting a video signal generated by the image capturing unit 3 (via a first interface 181) but also other functions enabling the camera device 1 to operate in conjunction with the telecommunications terminal 8. Specifically, the camera device 1 includes a second interface 182 for transmitting the result of detection by the detection unit 160 to the telecommunications terminal 8 via the communications unit 140. The camera device 1 further includes a third interface 183 for receiving a drive command to have the driving unit 30 controlled by the driving control unit 111 from the telecommunications terminal 8 via the communications unit 140.

That is to say, the camera system 100 according to this embodiment allows desired functions to be performed by making the camera device 1 operate in conjunction with the telecommunications terminal 8, thus contributing to expanding the range of applications of the camera device 1 even without changing the specifications of the camera device 1 itself. That is to say, this camera device 1 makes the result of detection by the detection unit 160 for use to control the driving unit 30 available to the telecommunications terminal 8 by transmitting the result of detection by the detection unit 160 to the telecommunications terminal 8 via the second interface 182. In addition, this camera device 1 also allows the telecommunications terminal 8 to control the driving unit 30 by receiving the drive command to control the driving unit 30 from the telecommunications terminal 8 via the third interface 183. This allows, even when the same camera device 1 is used, the camera system 100 to add various optional functions to the camera device 1 after its specification have been fixed, thus enabling the camera system 100 to perform a wider variety of functions.

Therefore, using this camera device 1 allows any desired function to be executed by the camera device 1 by making the user develop an application software program for performing the desired function by him- or herself, for example. This allows the range of applications of the camera device 1 to be significantly expanded on the user's own initiative, thus contributing to making the camera system 100 an even more popular product.

(2) Configuration

Next, a functional configuration for the camera system 100 according to this embodiment will be described in detail with reference to FIG. 1. The camera system 100 includes the camera device 1 and the telecommunications terminal 8 as described above.

The camera device 1 may be a mobile (portable) camera, for example, and includes an actuator 2 and an image capturing unit 3. The image capturing unit 3 may be rotated by the actuator 2 in tilting, panning, and rolling directions. The actuator 2 serves as a stabilizer 2a for driving the image capturing unit 3 in any desired rotational direction while reducing unwanted vibrations of the image capturing unit 3.

The camera device 1 includes the image capturing unit 3, the driving unit 30, the detection unit 160, the driving control unit 111, the communications unit 140, the first interface 181, the second interface 182, and the third interface 183. In this embodiment, the camera device 1 further includes a movable unit 10 (see FIG. 3A), a fixed unit 20 (see FIG. 3A), and a fourth interface 184. In the example illustrated in FIG. 1, the camera device 1 further includes a control unit 110, a driver unit 120, an image capturing control unit 150, an operating unit 170, and a storage unit 180. The driving unit 30, the detection unit 160, the driving control unit 111, and the driver unit 120 together form an actuator 2. The movable unit 10 holds the image capturing unit 3 and the fixed unit 20 holds the movable unit 10 in such a manner as to make the movable unit 10 movable. The movable unit 10 and the fixed unit 20 will be described in detail later in the “(4) Exemplary structure of camera device” section.

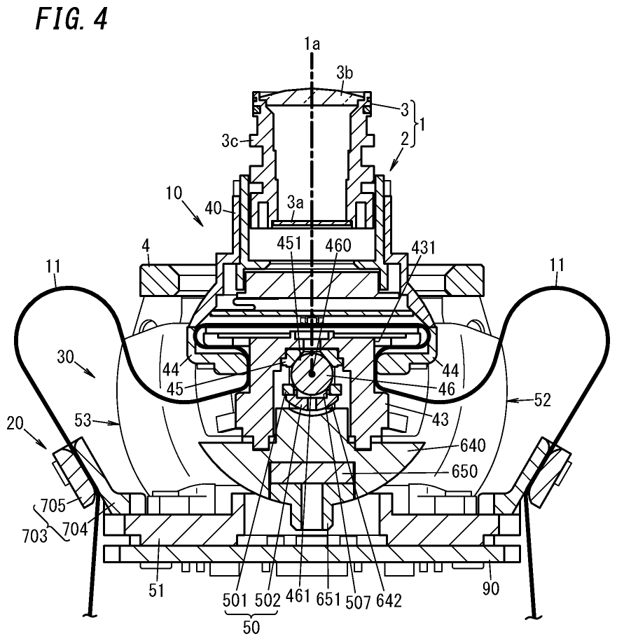

The image capturing unit 3 includes an image sensor 3a (see FIG. 4). The image capturing unit 3 converts video produced on the image capturing plane of the image sensor 3a into a video signal as an electrical signal. Also, a plurality of cables to transmit the electrical signal (video signal) generated by the image sensor 3a to an image processor circuit (as an exemplary external circuit) provided outside of the image capturing unit 3 are electrically connected to the image capturing unit 3 via connectors.

The driving unit 30 drives the movable unit 10 such that the movable unit 10 moves relative to the fixed unit 20. As will be described in detail later in the “(4) Exemplary structure of camera device” section, the driving unit 30 is an electromagnetic driver for driving the movable unit 10 by energizing the coils. The movable unit 10 holds the image capturing unit 3. Thus, the driving unit 30 driving the movable unit 10 causes the image capturing unit 3 to move along with the movable unit 10.

In this embodiment, the movable unit 10 (image capturing unit 3) is configured to be movable, relative to the fixed unit 20, in at least two directions selected from the group consisting of a panning direction, a tilting direction, and a rolling direction. As will be described in detail later in the “(4) Exemplary structure of camera device” section, the direction of movement of the movable unit 10 rotating around the optical axis 1a of the image capturing unit 3 (see FIG. 3A) will be hereinafter referred to as a “rolling direction.” The direction of movement of the movable unit 10 rotating around an X-axis will be hereinafter referred to as a “panning direction.” The direction of movement of the movable unit 10 rotating around a Y-axis will be hereinafter referred to as a “tilting direction.” The optical axis 1a of the image capturing unit 3 in a state where the movable unit 10 is not driven by the driving unit 30 (i.e., the state shown in FIG. 3A), the X-axis, and the Y-axis are perpendicular to each other.

The detection unit 160 detects the motion of at least one of the fixed unit 20 or the movable unit 10. Specifically, the detection unit 160 detects the “motion” of a target, which is at least one of the fixed unit 20 or the movable unit 10, by detecting, using a motion sensor such as an acceleration sensor or a gyrosensor, the acceleration applied to the target or an angular velocity thereof, for example. As used herein, the “motion” of the target includes the direction of movement, traveling velocity, angle of rotation, and posture (orientation) of the target.

In this embodiment, the detection unit 160 includes the gyrosensor 130, the relative position detection unit 131, and a detection processing unit 112. The gyrosensor 130 detects at least one of the angular velocity of the fixed unit 20 or the angular velocity of the movable unit 10. The relative position detection unit 131 detects the relative position of the movable unit 10 with respect to the fixed unit 20. In this embodiment, the gyrosensor 130 is mounted on a printed circuit board 90 (see FIG. 3A) included in the fixed unit 20 to detect the angular velocity of the fixed unit 20. Each of the gyrosensor 130 and the relative position detection unit 131 output the result of detection to the detection processing unit 112.

The detection processing unit 112 performs predetermined signal processing on the output signal of either the gyrosensor 130 or the relative position detection unit 131. The detection processing unit 112 may be implemented as, for example, a function of the control unit 110. The control unit 110 includes, as its major constituent element, a microcontroller including a processor and a memory, and performs the functions of the driving control unit 111 and other units by making its processor execute a program stored in its memory. The program may be stored in advance in the memory. Alternatively, the program may also be downloaded via a telecommunications line such as the Internet or distributed after having been stored on a storage medium such as a memory card.

The control unit 110 further has a function as the driving control unit 111. The driving control unit 111 drives the movable unit 10 by controlling the driving unit 30.

The driving control unit 111 controls the driving unit 30 based on a result of detection by the detection unit 160. The driving control unit 111 generates a drive signal for driving the movable unit 10 in each of the tilting, panning, and rolling directions. The driving control unit 111 outputs the drive signal to the driver unit 120. The drive signal is a signal generated by the pulse width modulation (PWM) and used to drive the movable unit 10 by changing the duty ratio at an arbitrary frequency.

The detection processing unit 112 performs signal processing for compensating for the vibrations, produced by a camera shake, for example, of the image capturing unit 3 based on the angular velocity detected by the gyrosensor 130 and the result of detection by a magnetic sensor 92 serving as the relative position detection unit 131 (to be described later). Specifically, the detection processing unit 112 calculates the angle of rotation of the image capturing unit 3 based on the result of detection by the gyrosensor 130 and the result of detection by the magnetic sensor 92 (relative position detection unit 131). The driving control unit 111 instructs the driver unit 120 to control the driving unit 30 so as to rotate the movable unit 10 by the angle of rotation obtained by the detection processing unit 112. This allows the actuator 2 to serve as a stabilizer 2a.

The frequency of the drive signal, i.e., a frequency corresponding to the duty ratio change rate, is high enough for the actuator 2 to serve as a stabilizer 2a, and may fall within the range from a few Hz to several ten Hz, for example. That is to say, the driving control unit 111 makes the actuator 2 serve as a stabilizer 2a for reducing unwanted vibrations of the image capturing unit 3 by controlling the driving unit 30 based on the result of detection by the detection unit 160. When the actuator 2 is made to serve as a stabilizer 2a, the drive signal suitably has a frequency of 40 to 50 Hz or less.

In addition, the driving control unit 111 also has the capability of controlling the driving unit 30 in accordance with a drive command received from the telecommunications terminal 8. The drive signal to be generated by the driving control unit 111 when the driving unit 30 is controlled in accordance with the drive command received from the telecommunications terminal 8 will be hereinafter referred to as a “signal for controlling.” The drive signal to be generated by the driving control unit 111 when the actuator 2 is made to serve as a stabilizer 2a will be hereinafter referred to as a “signal for vibration damping.”

In this case, if the frequency of the signal for controlling falls within the range from 100 Hz to 300 Hz, the user may be given a touch stimulus by the vibration of the movable unit 10. On the other hand, if the frequency of the signal for controlling falls within the range from 1 kHz to 8 kHz, an audible sound may be generated by the vibration of the movable unit 10. In this case, the audible sound may be a speech uttered by a human speaker. The audible sound does not have to be a speech but may also be a beep, a melody, or any other suitable sound. When the movable unit 10 vibrates, the fixed unit 20 also vibrates in synch with the vibration of the movable unit 10. That is to say, the vibration of the movable unit 10 sets up vibration of the entire camera device 1.

If the frequency of the signal for controlling is higher than the frequency of the signal for vibration damping, then the driving control unit 111 may output the signal for vibration damping and the signal for controlling such that these two signals are superposed one upon the other, thus allowing the movable unit 10 to be driven by the signal for controlling while the actuator 2 is operating as a stabilizer 2a, for example. That is to say, the driving control unit 111 outputs at least one of the signal for vibration damping and the signal for controlling as a drive signal. The frequency of the signal for controlling may overlap with the frequency range of the signal for vibration damping or may also be lower than the frequency of the signal for vibration damping.

The driver unit 120 is a driver circuit for running the driving unit 30 in accordance with a drive signal received from the driving control unit 111. That is to say, the driver unit 120 drives the movable unit 10 by supplying drive power to the driving unit 30 in accordance with the drive signal.

The communications unit 140 communicates wirelessly with the telecommunications terminal 8. The communication between the communications unit 140 and the telecommunications terminal 8 may be either Wi-Fi® or a wireless communication compliant with a low power radio standard (such as the Specific Low Power Radio standard) that requires no licenses, for example. As for this type of low power radio, the frequency band, antenna power, and other specific parameters to be adopted according to the intended use are defined in respective countries. In Japan, for example, a low power radio standard that requires the use of radio waves on the 920 MHz band or the 420 MHz band is defined.

The operating unit 170 has the capability of accepting the user's operating instructions The operating unit 170 is implemented as a single or a plurality of mechanical switches and accepts an operating instruction to “start capturing an image” or “stop capturing an image.” Alternatively, the operating unit 170 may also be implemented as a touchscreen panel, for example.

The image capturing control unit 150 controls the image capturing unit 3. For example, when the operating unit 170 accepts an operating instruction to “start capturing an image,” the image capturing control unit 150 controls the image capturing unit 3 to make the image capturing unit 3 start capturing an image. Specifically, the image capturing control unit 150 starts processing the video signal output by the image sensor 3a. On the other hand, when the operating unit 170 accepts an operating instruction to “stop capturing an image,” the image capturing control unit 150 controls the image capturing unit 3 to make the image capturing unit 3 finish (stop) capturing an image. The image capturing control unit 150 also has the capability of outputting the video data captured by the image capturing unit 3 to the first interface 181 (to be described later). In this embodiment, the image capturing control unit 150 is implemented as a function of the control unit 110 including a microcontroller as a major constituent element thereof. That is to say, the driving control unit 111, the detection processing unit 112, and the image capturing control unit 150 are implemented as a single microcontroller. Optionally, the image capturing control unit 150 may be implemented as another microcontroller separately from the driving control unit 111 and the detection processing unit 112. In addition, the image capturing control unit 150 also has the capability of storing video data (video signal) in either a built-in memory (such as the storage unit 180) of the camera device 1 or a storage medium such as a memory card.

The first interface 181 has the capability of outputting the video signal generated by the image capturing unit 3. In this embodiment, the first interface 181 acquires the video data (video signal) captured by the image capturing unit 3 from the image capturing control unit 150. The first interface 181 also has the capability of transmitting the video data (video signal) captured by the image capturing unit 3 to a recorder, a display device, or any other external device outside of the camera device 1 via the communications unit 140. In addition, the first interface 181 is further configured to transmit the video data (video signal) captured by the image capturing unit 3 to the telecommunications terminal 8 via the communications unit 140.

The second interface 182 is configured to transmit the result of detection by the detection unit 160 to the telecommunications terminal 8 via the communications unit 140. In this embodiment, the output signal of the gyrosensor 130 or relative position detection unit 131 is subjected to a predetermined type of signal processing by the detection processing unit 112 and then provided as the result of detection by the detection unit 160 from the second interface 182 to the telecommunications terminal 8.

The third interface 183 is configured to receive, from the telecommunications terminal 8 via the communications unit 140, a drive command to have the driving unit 30 controlled by the driving control unit 111. In this embodiment, the third interface 183 accepts a control command in accordance with a prescribed protocol as the drive command from the telecommunications terminal 8. The drive command accepted by the third interface 183 is output to the driving control unit 111. This allows the driving control unit 111 to control, with the signal for controlling, the driving unit 30 in accordance with the drive command.

The fourth interface 184 is configured to receive, from the telecommunications terminal 8 via the communications unit 140, an image capture command to have the image capturing unit 3 controlled by the image capturing control unit 150. In this embodiment, the fourth interface 184 accepts a control command in accordance with a prescribed protocol as the image capture command from the telecommunications terminal 8. The image capture command accepted by the fourth interface 184 is output to the image capturing control unit 150. This allows the image capturing control unit 150 to control the image capturing unit 3 such that the image capturing unit 3 starts or finishes (stops) capturing an image in accordance with the image capture command, for example. Thus, the image capturing control unit 150 is able to control the image capturing unit 3 in accordance with not only the operating instruction accepted by the operating unit 170 but also the image capture command received from the telecommunications terminal 8 as well.

The storage unit 180 is implemented as a device selected from the group consisting of a read-only memory (ROM), a random access memory (RAM), an electrically erasable programmable read-only memory (EEPROM), and other storage devices.

Next, a configuration for the telecommunications terminal 8 will be described.

The telecommunications terminal 8 may be a mobile telecommunications terminal such as a smartphone, a tablet computer, or a wearable device. As shown in FIG. 1, the telecommunications terminal 8 includes a terminal-end communications unit 81, a camera-terminal interface 82, and a user interface 83.

The telecommunications terminal 8 is a computer system including a central processing unit (CPU) and a memory. Installing dedicated application software in the computer system and starting the application software allows the computer system (telecommunications terminal 8) to serve as the camera-terminal interface 82 (including the acquisition unit 821 and the command giving unit 822). The application software (program) may be stored in advance in a memory. Alternatively, the program may also be downloaded via a telecommunications line such as the Internet or distributed after having been stored on a storage medium such as a memory card.

The terminal-end communications unit 81 communicates with (the communications unit 140 of) the camera device 1. The user interface 83 includes a touchscreen panel display, for example, and presents information on the display to the user of the telecommunications terminal 8 and accepts the user's operating instructions entered through a touch operation. Alternatively, the user interface 83 may also present information as a sound to the user and accept the user's operating instructions entered as speech, for example.

The camera-terminal interface 82 is an interface that allows the camera device 1 and the telecommunications terminal 8 to operate in conjunction with each other. The camera-terminal interface 82 performs the functions of the acquisition unit 821 and the command giving unit 822. The acquisition unit 821 is configured to acquire the result of detection by the detection unit 160 from the second interface 182. The command giving unit 822 is configured to give a drive command to the third interface 183.

The telecommunications terminal 8 further includes a motion sensor, a vibrator, and other additional devices. This allows the telecommunications terminal 8, as well as the camera device 1 with the detection unit 160, to detect acceleration applied to the telecommunications terminal 8 or the angular velocity thereof using the motion sensor. In addition, this also allows the telecommunications terminal 8, as well as the camera device 1 with the actuator 2, to be vibrated with the vibrator.

(3) Operation

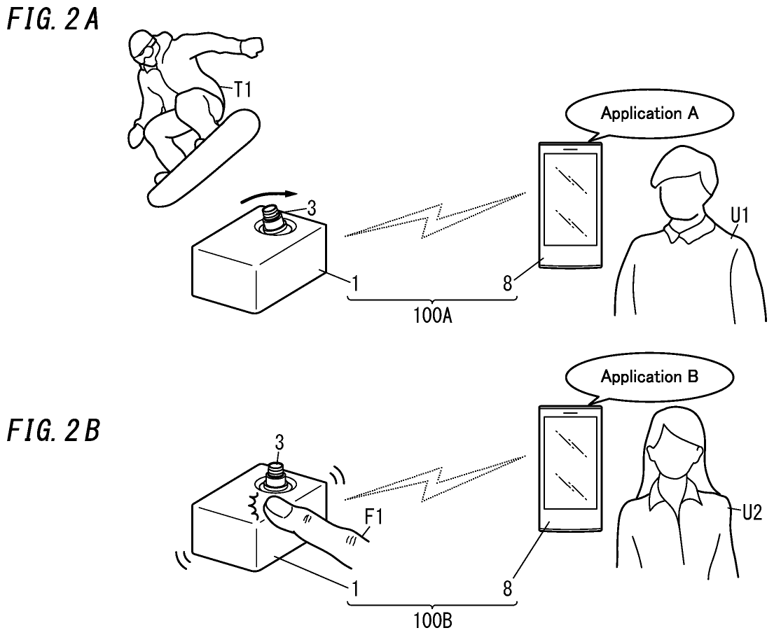

Next, it will be described with reference to FIGS. 2A and 2B how the camera system 100 according to this embodiment operates. Note that FIGS. 2A and 2B are just schematic representations for use to illustrate exemplary applications of the camera system 100. Thus, the shapes, dimensions, and relative positions of the respective members illustrated on these drawings may be somewhat different from actual ones.

A basic operation of the camera system 100 according to this embodiment is reducing (or compensating for) the blur of video, caused by the vibrations (such as a shake) of the camera device 1 due to the user's hand tremor, for example, by making the actuator 2 serve as a stabilizer 2a. Such a basic operation of making the actuator 2 serve as a stabilizer 2a is carried out by having the driving control unit 111 control the driving unit 30 based on the result of detection by the detection unit 160, and therefore, may be performed by the camera device 1 by itself. That is to say, even if the user who is carrying the camera device 1 with him or her has moved, the blur of the video shot by the camera device 1 is still compensated for. The camera device 1 of this type may be worn, as a so-called “wearable camera,” by the user on some body part such as his or her head, arm, or waist or on his or her clothes and may be used by the user to shoot video from his or her viewpoint while he or she is exercising, for example.

In addition, since the camera device 1 and the telecommunications terminal 8 perform a desired function by operating in conjunction with each other, the camera system 100 according to this embodiment is able to perform different functions by changing the application software installed in the telecommunications terminal 8 while using the same camera device 1. That is to say, the camera device 1 includes the interfaces (such as the second interface 182 and the third interface 183) allowing the camera device 1 to operate in conjunction with the telecommunications terminal 8, thus allowing the camera system 100 to perform various functions depending on the telecommunications terminal 8. Thus, installing a variety of application software in the telecommunications terminal 8 allows the camera system 100 to add various expanded functions (add-on) to the basic operation described above. Some specific examples of those expanded functions to be performed by the camera system 100 according to this embodiment will now be described.

(3.1) First Specific Example

A camera system 100A according to a first specific example is implemented as a combination of the camera device 1 and a user's U1 telecommunications terminal 8 as shown in FIG. 2A. Application A, which is a piece of application software, has been installed in the user's U1 telecommunications terminal 8.

In this camera system 100A, at least video data (video signal) captured by the image capturing unit 3 is transmitted from the camera device 1 to the telecommunications terminal 8 via the first interface 181. In addition, in this camera system 100A, at least a drive command to have the driving unit 30 controlled by the driving control unit 111 is transmitted from the telecommunications terminal 8 to the camera device 1 via the third interface 183.

The “Application A” makes the telecommunications terminal 8 perform image processing on the video signal received from the camera device 1 to extract a target T1 as a subject image (e.g., a person who is snowboarding) from the video. The telecommunications terminal 8 generates a drive command to control the driving unit 30 such that the movement of the target T1 extracted should be followed within the video. In this case, the target T1 may be either designated manually by the user U1 by operating his or her telecommunications terminal 8 or be extracted and entered automatically through image processing. This allows the camera system 100A to perform the function of automatically tracking the target T1 being shot by the image capturing unit 3.

Also, in this first specific example, the telecommunications terminal 8 determines the orientation of the optical axis 1a of the image capturing unit 3 in an absolute coordinate system with respect to the Z-axis (hereinafter referred to as an “absolute angle”) so as to track the target T1 extracted. In that case, the camera device 1 controls the driving unit 30 to make the driving control unit 111 perform the basic operation to change the orientation of the optical axis 1a of the image capturing unit 3 relative to the absolute angle based on the result of detection by the detection unit 160. This allows the camera system 100A to compensate for the blur of the video shot by the camera device 1 through the basic operation of making the actuator 2 serve as a stabilizer 2a while automatically tracking the target T1 that is being shot by the image capturing unit 3.

(3.2) Second Specific Example

A camera system 100B according to a second specific example is implemented as a combination of the camera device 1 and a user's U2 telecommunications terminal 8 as shown in FIG. 2B. Application B, which is a piece of application software, has been installed in the user's U2 telecommunications terminal 8.

In this camera system 100B, at least the result of detection by the detection unit 160 is transmitted from the camera device 1 to the telecommunications terminal 8 via the second interface 182. In addition, in this camera system 100B, at least an image capture command to have the image capturing unit 3 controlled by the image capturing control unit 150 is transmitted from the telecommunications terminal 8 to the camera device 1 via the fourth interface 184.

The Application B makes the telecommunications terminal 8 determine, based on the result of detection by the detection unit 160 received from the camera device 1, whether or not the user U2 has performed any tap operation on the camera device 1. As used herein, the “tap operation” refers to the operation of lightly tapping the camera device 1 with a finger F1, for example. Every time the camera device 1 is lightly tapped once, the number of times of tap operations (or the tap count) increases by one. Based on the number of times the tap operation has been detected during a certain amount of time of three seconds, for example (hereinafter referred to as “the number of times of taps”), the telecommunications terminal 8 generates an image capture command to control the image capturing unit 3 and transmits the command to the camera device 1. Suppose the number of times of taps “twice” is associated with a command to “start capturing an image” and the number of times of taps “three times” is associated with a command to “stop capturing an image,” for example. In that case, when finding the number of times of taps to be twice, the telecommunications terminal 8 generates an image capture command that image capturing should be started. On the other hand, when finding the number of times of taps to be three times, the telecommunications terminal 8 generates an image capture command that image capturing should be stopped. This allows the camera system 100B to perform the function of controlling the image capturing unit 3 through the tap operation on the camera device 1.

Also, in this second specific example, the camera system 100B may be further provided with an additional function of responding (answering back) to the user's U2 tap operation. In that case, at least a drive command to have the driving unit 30 controlled by the driving control unit 111 is transmitted from the telecommunications terminal 8 to the camera device 1 via the third interface 183. This allows, when the telecommunications terminal 8 detects the user's U2 tap operation, the camera system 100B to return response to the user U2 by either giving touch stimulus to his or her finger F1 through vibration of the movable unit 10 or emitting an audible sound.

Alternatively, in this second specific example, the processing of detecting the tap operation may be performed by the camera device 1. In that case, the telecommunications terminal 8 operates to specify the correspondence between the tap operation (the number of times of taps) and the drive command to give.

Optionally, in this second specific example, the telecommunications terminal 8, as well as the camera device 1, may be configured to accept the tap operation. The telecommunications terminal 8 includes the motion sensor as described above. Thus, even if the tap operation has been performed on the telecommunications terminal 8, the telecommunications terminal 8 is able to generate an image capture command to control the image capturing unit 3 according to the number of times of taps and transmit the image capture command to the camera device 1. In that case, the telecommunications terminal 8 may respond (answer back) to the user's U2 tap operation using its vibrator, for example.

(3.3) Other Specific Examples

Note that the first and second specific examples are only exemplary functions to be performed by the camera system 100 and should not be construed as limiting. Rather, the camera system 100 is also able to perform the following various other functions using application software installed in the telecommunications terminal 8.

In one example, the camera system 100 may also perform the function of allowing the user to remote-control, using the telecommunications terminal 8 in his or her hand, the camera device 1 set up on a tripod, for example. In that case, at least a drive command to have the driving unit 30 controlled by the driving control unit 111 is transmitted from the telecommunications terminal 8 to the camera device 1 via the third interface 183. In addition, at least an image capture command to have the image capturing unit 3 controlled by the image capturing control unit 150 is also transmitted from the telecommunications terminal 8 to the camera device 1 via the fourth interface 184.

In another example, the camera system 100 may also perform the function of selectively instructing, according to the user's current location, the camera device 1 worn by the user to capture an image only while he or she is passing through a designated shooting area. The user's current location may be estimated by the telecommunications terminal 8 using the global positioning system (GPS), for example. Specifically, in that case, the telecommunications terminal 8 transmits, when finding the user's current location falling within the shooting area, an image capture command to “start capturing an image” to the camera device 1, and also transmits, when finding the user's current location falling out of the shooting area, an image capture command to “stop capturing an image” to the camera device 1. In that case, at least an image capture command to have the image capturing unit 3 controlled by the image capturing control unit 150 is transmitted from the telecommunications terminal 8 to the camera device 1 via the fourth interface 184.

In still another example, the camera system 100 may also perform a shooting exercise function by magnifying the blur of the video caused by the shooter's hand tremor, for example. In that case, at least the result of detection by the detection unit 160 is transmitted from the camera device 1 to the telecommunications terminal 8 via the second interface 182. In addition, at least a drive command to have the driving unit 30 controlled by the driving control unit 111 is also transmitted from the telecommunications terminal 8 to the camera device 1 via the third interface 183.

In yet another example, the camera system 100 may also perform a call function similar to that of a string telephone between a plurality of camera devices 1. Specifically, when a plurality of camera devices 1 are connected to the same telecommunications terminal 8, a first one of the camera devices 1 may detect, using its own detection unit 160, a sound as its own vibration, and then a second one of the camera devices 1 may output, as vibration of its own movable unit 10, the transmitted sound as an audible sound. In that case, at least the result of detection by the detection unit 160 is transmitted from the first camera device 1 to the telecommunications terminal 8 via the second interface 182. In addition, at least a drive command to have the driving unit 30 controlled by the driving control unit 111 is also transmitted from the telecommunications terminal 8 to the second camera device 1 via the third interface 183.

In yet another example, the camera system 100 may further perform the function of generating, with the light emitted from a point light source, two-dimensional video in the video shot by shifting the image capturing unit 3 relative to the point light source with the shutter of the image capturing unit 3 opened. In that case, at least a drive command to have the driving unit 30 controlled by the driving control unit 111 is transmitted from the telecommunications terminal 8 to the second camera device 1 via the third interface 183.

In yet another example, the camera system 100 may also perform the function of a controller for a game console. For example, when a virtual sport game that uses an imaginary racket for table tennis, for example, is being displayed on a game screen generated by the telecommunications terminal 8, the user may hold the camera device 1 in his or her hand instead of a real racket and swing the camera device 1 as if he or she were playing table tennis. In such a situation, the swing of the camera device 1 held in the user's hand is emulated by a synchronized movement of the racket held in a virtual player's hand on the game screen. In that case, the telecommunications terminal 8 calculates, based on the result of detection by the detection unit 160 received from the camera device 1, the position, swing speed, and other parameters of the racket (camera device 1). In this particular application, to give the user a touch stimulus emulating the impact of a ball hitting the racket (camera device 1), at least a drive command to have the driving unit 30 controlled by the driving control unit 111 is suitably transmitted from the telecommunications terminal 8 to the second camera device 1 via the third interface 183.

(4) Exemplary Structure of Camera Device

Next, an exemplary specific structure of the camera device 1 according to this embodiment will be described with reference to FIGS. 3A-6.

The image capturing unit 3 includes an image sensor 3a, a lens 3b for forming a subject image on the image capturing plane of the image sensor 3a, and a lens barrel 3c for holding the lens 3b (see FIG. 4). The lens barrel 3c protrudes from the actuator 2 along the optical axis 1a of the image capturing unit 3. The lens barrel 3c has a circular cross section when taken perpendicularly to the optical axis 1a. Also, a plurality of cables connected to the image capturing unit 3 includes coplanar waveguides or micro-strip lines. Alternatively, the plurality of cables may include fine-line coaxial cables each having the same length. Those cables are grouped into a predetermined number of bundles of cables 11.

The actuator 2 (camera device 1) includes an upper ring 4, a movable unit 10, a fixed unit 20, a driving unit 30, and a printed circuit board 90 as shown in FIGS. 3A and 4.

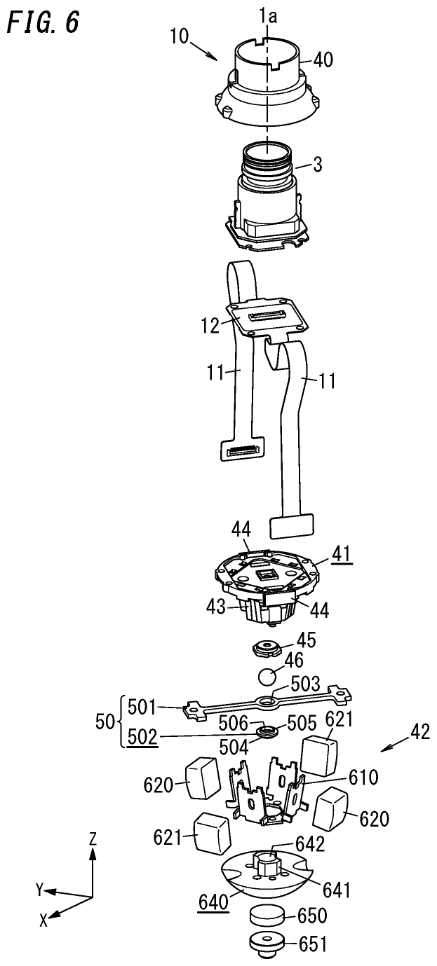

The movable unit 10 includes a camera holder 40, a first movable base 41, and a second movable base 42 (see FIG. 6). The movable unit 10 is fitted into the fixed unit 20 with some gap left between the movable unit 10 and the fixed unit 20. The movable unit 10 rotates (i.e., rolls) around the optical axis 1a of the lens of the image capturing unit 3 with respect to the fixed unit 20.

In the following description, a position of the movable unit 10 (image capturing unit 3) not driven by the driving unit 30 (i.e., the position shown in FIG. 3A and other drawings) will be defined herein to be a “neutral position.” In this embodiment, the direction in which the optical axis 1a extends when the movable unit 10 is in the neutral position will be hereinafter referred to as a “Z-axis direction.” The Z-axis direction is aligned with a fitting direction in which the movable unit 10 is fitted into the fixed unit 20. Furthermore, the direction in which the lens barrel 3c protrudes from the actuator 2 along the Z-axis will be hereinafter referred to as an “upward direction.” That is to say, the movable unit 10 in the neutral position is rotatable around the Z-axis. The movable unit 10 also rotates around X- and Y-axes with respect to the fixed unit 20. In this case, both of the X- and Y-axes are perpendicular to the Z-axis. In addition, the X- and Y-axes are perpendicular to each other.

In the following description, the direction in which the movable unit 10 (image capturing unit 3) rotates around the X-axis is defined herein to be a “panning direction” and the direction in which the movable unit 10 (image capturing unit 3) rotates around the Y-axis is defined herein to be a “tilting direction.” Furthermore, the direction in which the movable unit 10 (image capturing unit 3) rotates (rolls) around the optical axis 1a is defined herein to be a “rolling direction.” A detailed configuration of the movable unit 10 will be described later. Note that all of the optical axis 1a and the X-, Y-, and Z-axes are virtual axes, and the arrows indicating the X-, Y-, and Z-axes on the drawings are just shown there for the sake of description and are insubstantial ones. It should also be noted that these directions should not be construed as limiting the directions in which the camera device 1 is used.

The image capturing unit 3 is attached to the camera holder 40. The configuration of the first movable base 41 and the second movable base 42 will be described later. Rotation of the movable unit 10 allows the image capturing unit 3 to rotate as well.

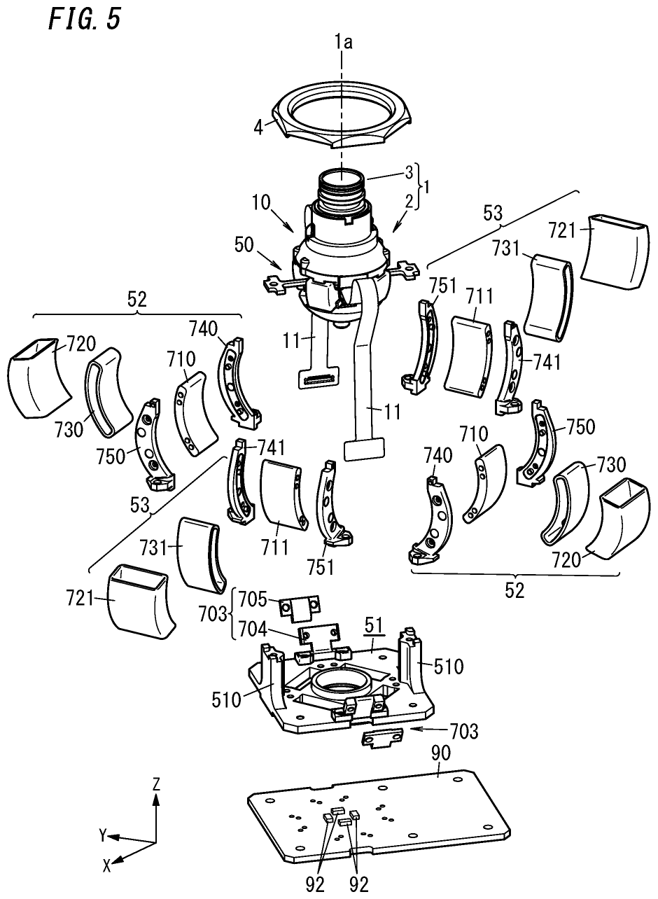

The fixed unit 20 includes a coupling member 50 and a body 51 (see FIG. 5).

The coupling member 50 includes a linear coupling bar 501 and a loosely fitting member 502 (see FIG. 6). The coupling bar 501 has an opening 503 cut through a middle of the length thereof. The loosely fitting member 502 includes a base 504 and a wall 505 (see FIG. 6). When viewed downward from over the base 504 (i.e., in a plan view), the base 504 has a circular shape. One surface, closer to the image capturing unit 3, of the base 504 (i.e., its upper surface) is a flat surface, while the other surface, more distant from the image capturing unit 3, of the base 504 (i.e., its lower surface) is a spherical surface. A central portion of the upper surface of the base 504 has a recess 506 (see FIG. 6). The wall 505 protrudes upward from around the recess 506 of the base 504 (see FIG. 6). The inner peripheral surface of the wall 505, i.e., the surface facing the recess 506, constitutes a second loosely fitting surface 507 (to be described later) (see FIG. 4). The diameter of the outer periphery of the wall 505 is approximately equal to the diameter of the opening 503 of the coupling bar 501. The wall 505 is fitted into the opening 503 of the coupling bar 501.

The body 51 includes a pair of protrusions 510. The pair of protrusions 510 are provided so as to face each other in a direction perpendicular to the Z-axis and forming an angle of 45 degrees with respect to the X- and Y-axes. The pair of protrusions 510 is also provided to be located in the gaps between first coil units 52 and second coil units 53 arranged (to be described later). The coupling member 50 is screwed onto the body 51 with the second movable base 42 interposed between itself and the body 51. Specifically, both longitudinal ends of the coupling member 50 are respectively screwed onto the pair of protrusions 510 of the body 51.

The body 51 is provided with two fixing portions 703 for fixing the two bundles of cables 11 thereto (see FIGS. 3A and 4). The two fixing portions 703 are arranged to face each other in a direction perpendicular to not only the Z-axis but also the direction in which the pair of protrusions 510 face each other. The two fixing portions 703 are provided to tilt with respect to the Z-axis such that the interval between the two fixing portions 703 broadens toward the image capturing unit 3 in the Z-axis direction (see FIG. 5). Each of the two fixing portions 703 includes a first member 704 and a second member 705, both of which are formed in a plate shape. An associated bundle of cables 11 is partially clamped between the first and second members 704 and 705.

The fixed unit 20 includes a pair of first coil units 52 and a pair of second coil units 53 to make the movable unit 10 electromagnetically drivable and rotatable (see FIG. 3B). The pair of first coil units 52 face each other in the Y-axis direction. The pair of second coil units 53 face each other in the X-axis direction. The pair of first coil units 52 allows the movable unit 10 to rotate around the X-axis. The pair of second coil units 53 allows the movable unit 10 to rotate around the Y-axis.

The pair of first coil units 52 each include a first magnetic yoke 710 made of a magnetic material, drive coils 720 and 730, and magnetic yoke holders 740 and 750 (see FIG. 5). Each of the first magnetic yokes 710 has the shape of an arc, of which the center is defined by the center of rotation 460 (see FIG. 4). The drive coils 730 are each formed by winding a conductive wire around its associated first magnetic yoke 710 such that its winding direction is defined around the X-axis (i.e., the direction in which the second coil units 53 face each other) and that the pair of first drive magnets 620 (to be described later) is driven in rotation in the rolling direction. As used herein, the winding direction of the coil refers in this embodiment to a direction in which the number of turns increases. Furthermore, the magnetic yoke holders 740 and 750 are secured with screws onto the first magnetic yoke 710 on both sides thereof. Thereafter, the drive coils 720 are each formed by winding a conductive wire around its associated first magnetic yoke 710 such that its winding direction is defined around the Z-axis and that the pair of first drive magnets 620 is driven in rotation in the panning direction. Then, the pair of first coil units 52 is secured with screws onto the body 51 so as to face each other when viewed from the image capturing unit 3. Specifically, each of the first coil units 52 has one end thereof along the Z-axis (i.e., the end opposite from the image capturing unit 3) secured with a screw onto the body 51. Each of the first coil units 52 has the other end thereof along the Z-axis (i.e., the end closer to the image capturing unit 3) fitted into the upper ring 4.

The pair of second coil units 53 each include a second magnetic yoke 711 made of a magnetic material, drive coils 721 and 731, and magnetic yoke holders 741 and 751 (see FIG. 5). Each of the second magnetic yokes 711 has the shape of an arc, of which the center is defined by the center of rotation 460 (see FIG. 4). The drive coils 731 are each formed by winding a conductive wire around its associated second magnetic yoke 711 such that its winding direction is defined around the Y-axis (i.e., the direction in which the first coil units 52 face each other) and that the pair of second drive magnets 621 (to be described later) is driven in rotation in the rolling direction. Furthermore, the magnetic yoke holders 741 and 751 are secured with screws onto the second magnetic yoke 711 on both sides thereof. Thereafter, the drive coils 721 are each formed by winding a conductive wire around its associated second magnetic yoke 711 such that its winding direction is defined around the Z-axis and that the pair of second drive magnets 621 is driven in rotation in the tilting direction. Then, the pair of second coil units 53 is secured with screws onto the body 51 so as to face each other when viewed from the image capturing unit 3. Specifically, each of the second coil units 53 has one end thereof along the Z-axis (i.e., the end opposite from the image capturing unit 3) secured with a screw onto the body 51. Each of the second coil units 53 has the other end thereof along the Z-axis (i.e., the end closer to the image capturing unit 3) fitted into the upper ring 4.

The camera holder 40 on which the image capturing unit 3 has been mounted is secured with screws onto the first movable base 41. The coupling member 50 is interposed between the first movable base 41 and the second movable base 42.

The printed circuit board 90 includes a plurality of (e.g., four in this embodiment) magnetic sensors 92 for detecting rotational positions in the panning and tilting directions of the image capturing unit 3. In this embodiment, the magnetic sensors 92 may be implemented as Hall elements, for example. However, this is only an example and should not be construed as limiting. Alternatively, the magnetic sensors 92 may also be sensors using magnetoresistance elements or coils, for example.

On the printed circuit board 90, further assembled are a circuit for controlling the amount of a current allowed to flow through the drive coils 720, 721, 730, and 731 and other circuits. Examples of the other circuits assembled on the printed circuit board 90 include a circuit having the capability of a driver unit 120 shown in FIG. 1 and the gyrosensor 130 shown in FIG. 1. A microcontroller or any other microprocessor may be further built on the printed circuit board 90.

Next, detailed configurations for the first movable base 41 and the second movable base 42 will be described.

The first movable base 41 includes a body 43, a pair of holding portions 44, a loosely fitting member 45, and a sphere 46 (see FIG. 6). The body 43 sandwiches a rigid portion 12 between itself and the camera holder 40 to fix (hold) the rigid portion 12 thereon. The respective holding portions 44 are provided for the peripheral edge of the body 43 so as to face each other (see FIG. 6). Each holding portion 44 clamps and holds an associated bundle of cables 11 between itself and a sidewall 431 of the body 43 (see FIG. 4). The loosely fitting member 45 has a through hole 451 running through the loosely fitting member 45 in the Z-axis direction (see FIG. 4). The inner peripheral surface of the through hole 451 is tapered such that the through hole 451 increases its diameter along the Z-axis in a direction going away from the image capturing unit 3.

The sphere 46 is fitted and fixed into the through hole 451 of the loosely fitting member 45 and has a first loosely fitting surface 461 as a raised spherical surface (see FIG. 4). The sphere 46 is loosely fitted into the loosely fitting member 502 such that a narrow gap is left between the first loosely fitting surface 461 and a second loosely fitting surface 507 of the loosely fitting member 502 (i.e., the inner peripheral surface of the wall 505). This allows the coupling member 50 to pivotally support the movable unit 10 to make the movable unit 10 rotatable. In this case, the center of mass of the sphere 46 defines the center of rotation 460 of the movable unit 10.

The second movable base 42 supports the first movable base 41. The second movable base 42 includes a back yoke 610, a pair of first drive magnets 620, and a pair of second drive magnets 621 (see FIG. 6). The second movable base 42 further includes a bottom plate 640, a position detecting magnet 650, and a stopper member 651 (see FIG. 6).

The back yoke 610 includes a disk portion and four fixing portions (arms) extending from the outer periphery of the disk portion toward the image capturing unit 3 (i.e., upward). Two out of the four fixing portions face each other along the X-axis, while the other two fixing portions face each other along the Y-axis. The two fixing portions facing each other along the Y-axis respectively face the pair of first coil units 52. The two fixing portions facing each other along the X-axis respectively face the pair of second coil units 53.

The pair of first drive magnets 620 are respectively fixed to two fixing portions, facing each other along the Y-axis, out of the four fixing portions of the back yoke 610. The pair of second drive magnets 621 are respectively fixed to two fixing portions, facing each other along the X-axis, out of the four fixing portions of the back yoke 610.

Electromagnetic driving by the first drive magnets 620 and the first coil units 52 and electromagnetic driving by the second drive magnets 621 and the second coil units 53 allow the movable unit 10 (image capturing unit 3) to rotate in the panning, tilting, and rolling directions. Specifically, electromagnetic driving by the two drive coils 720 and the two first drive magnets 620 and electromagnetic driving by the two drive coils 721 and the two second drive magnets 621 allow the movable unit 10 to rotate in the panning and tilting directions. Meanwhile, electromagnetic driving by the two drive coils 730 and the two first drive magnets 620 and electromagnetic driving by the two drive coils 731 and the two second drive magnets 621 allow the movable unit 10 to rotate in the rolling direction.

The bottom plate 640 is a non-magnetic member and may be made of brass, for example. The bottom plate 640 is attached to the back yoke 610 to define the bottom of the movable unit 10 (i.e., the bottom of the second movable base 42). The bottom plate 640 is secured with screws onto the back yoke 610 and the first movable base 41. The bottom plate 640 serves as a counterweight. Having the bottom plate 640 serve as a counterweight allows the center of rotation 460 to agree with the center of gravity of the movable unit 10. That is why when external force is applied to the entire movable unit 10, the moment of rotation of the movable unit 10 around the X-axis and the moment of rotation of the movable unit 10 around the Y-axis both decrease. This allows the movable unit 10 (or the image capturing unit 3) to be held in the neutral position, or to rotate around the X- and Y-axes, with less driving force.

One surface, located closer to the image capturing unit 3 (i.e., the upper surface), of the bottom plate 640 is a flat surface, and a central portion of the upper surface has a projection 641. The projection 641 has a recess 642 at the tip. The bottom of the recess 642 is a downwardly protruding, curved surface. The loosely fitting member 502 is located closer to the image capturing unit 3 than (i.e., arranged over) the recess 642 (see FIG. 4).

The other surface, located more distant from the image capturing unit 3 (i.e., the lower surface), of the bottom plate 640 is a spherical surface, and a central portion of the lower surface has a recess. In the recess, arranged are the position detecting magnet 650 and the stopper member 651 (see FIG. 4). The stopper member 651 prevents the position detecting magnet 650, arranged in the recess of the bottom plate 640, from falling off.

A gap is left between the recess 642 of the bottom plate 640 and the loosely fitting member 502 (see FIG. 4). The bottom of the recess 642 of the bottom plate 640 and the lower surface of the base 504 of the loosely fitting member 502 are curved surfaces that face each other. This gap is wide enough to allow, even when the loosely fitting member 502 comes into contact with the bottom plate 640, the first drive magnets 620 and the second drive magnets 621 to go back to their home positions due to their own magnetism. Thus, even if the image capturing unit 3 has moved along the Z-axis, the movable unit 10 (image capturing unit 3) is still able to go back to its home position.

The four magnetic sensors 92 provided for the printed circuit board 90 detect, based on the relative position of the position detecting magnet 650 with respect to the four magnetic sensors 92, the relative rotation (movement) of the movable unit 10 with respect to the fixed unit 20. That is to say, the four magnetic sensors 92 form at least part of the relative position detection unit 131 for detecting the relative position of the movable unit 10 with respect to the fixed unit 20. That is to say, as the movable unit 10 rotates (moves), the position detecting magnet 650 changes its position, thus causing a variation in the magnetic force applied to the four magnetic sensors 92. The four magnetic sensors 92 detect this variation in the magnetic force, and calculate two-dimensional angles of rotation with respect to the X- and Y-axes. This allows the four magnetic sensors 92 to detect the angles of rotation of the movable unit 10 in the tilting and panning directions.

In addition, the camera device 1 further includes, separately from the four magnetic sensors 92, another magnetic sensor for detecting the rotation of the movable unit 10 (i.e., the rotation of the image capturing unit 3) around the optical axis 1a, i.e., a magnetic sensor for detecting the rotation in the rolling direction of the movable unit 10. Note that the sensor for detecting the rotation in the rolling direction of the movable unit 10 does not have to be a magnetic sensor but may also be a gyrosensor or a capacitance sensor, for example. Optionally, the rotation in the rolling direction of the movable unit 10 may be estimated by the force that causes the movable unit 10 to try to return to the origin (i.e., the stability point) under the magnetic attraction produced between the movable unit 10 and the fixed unit 20, i.e., by so-called “magnetic spring.” That is to say, the camera device 1 may estimate, based on DC components (low frequency components) of either the drive signal or a signal output from the driver unit 120 to the drive coils 730 and 731, the relative rotation (movement) in the rolling direction of the movable unit 10 with respect to the fixed unit 20.

In this case, the pair of first drive magnets 620 serves as attracting magnets, thus producing first magnetic attraction forces between the pair of first drive magnets 620 and the first magnetic yokes 710 that face the first drive magnets 620. Likewise, the pair of second drive magnets 621 also serves as attracting magnets, thus producing second magnetic attraction forces between the pair of second drive magnets 621 and the second magnetic yokes 711 that face the second drive magnets 621. The vector direction of each of the first magnetic attraction forces is parallel to a centerline that connects together the center of rotation 460, the center of mass of an associated one of the first magnetic yokes 710, and the center of mass of an associated one of the first drive magnets 620. The vector direction of each of the second magnetic attraction forces is parallel to a centerline that connects together the center of rotation, the center of mass of an associated one of the second magnetic yokes 711, and the center of mass of an associated one of the second drive magnets 621.

The first and second magnetic attraction forces become normal forces produced by the fixed unit 20 with respect to the sphere 46 of the loosely fitting member 502. Also, when the movable unit 10 is in the neutral position, the magnetic attraction forces of the movable unit 10 define a synthetic vector in the Z-axis direction. This force balance between the first magnetic attraction forces, the second magnetic attraction forces, and the synthetic vector resembles the dynamic configuration of a balancing toy, and allows the movable unit 10 to rotate in three axis directions with good stability.

In this embodiment, the pair of first coil units 52, the pair of second coil units 53, the pair of first drive magnets 620, and the pair of second drive magnets 621 together form the driving unit 30. The driving unit 30 includes a first driving unit for rotating the movable unit 10 in the panning direction, a second driving unit for rotating the movable unit 10 in the tilting direction, and a third driving unit for rotating the movable unit 10 in the rolling direction. The first driving unit includes the pair of first magnetic yokes 710 and pair of drive coils 720 included in the pair of first coil units 52, and the pair of first drive magnets 620. The second driving unit includes the pair of second magnetic yokes 711 and pair of drive coils 721 included in the pair of second coil units 53, and the pair of second drive magnets 621. The third driving unit includes the pair of first drive magnets 620, the pair of second drive magnets 621, the pair of first magnetic yokes 710, the pair of second magnetic yokes 711, the pair of drive coils 730, and the pair of drive coils 731.

The camera device 1 of this embodiment allows the movable unit 10 to rotate two-dimensionally (i.e., pan and tilt) by supplying electricity to the pair of drive coils 720 and the pair of drive coils 721 simultaneously. In addition, the camera device 1 also allows the movable unit 10 to rotate (i.e., to roll) around the optical axis 1a by supplying electricity to the pair of drive coils 730 and the pair of drive coils 731 simultaneously.

(5) Variations

Note that the embodiment described above is only an example of various embodiments of the present disclosure and should not be construed as limiting. Rather, the embodiment may be readily modified in various manners, depending on a design choice or any other factor, without departing from a scope of the present invention. Also, the function of the telecommunications terminal 8 of the camera system 100 may also be implemented as a computer program, a storage medium that stores a program, or a camera control method, for example. A (computer) program according to an aspect is a program designed to make a computer system (telecommunications terminal 8) with the capability of communicating with the camera device 1 serve as an acquisition unit 821 and a command giving unit 822. The acquisition unit 821 acquires the result of detection by the detection unit 160 from the second interface 182. The command giving unit 822 gives a drive command to the third interface 183.

Next, variations of the exemplary embodiment described above will be enumerated one after another. Note that any of the variations to be described below may be combined as appropriate.

The telecommunications terminal 8 does not have to be a mobile telecommunications terminal such as a smartphone, a tablet computer, or a wearable device, but may also be a dedicated information terminal installed at a fixed location, a personal computer, or an telecommunications terminal such as a smart TV connectible to a network, for example.

The method of communication between the camera device 1 (communications unit 140) and the telecommunications terminal 8 does not have to be wireless communication but may also be wired communication. Optionally, the camera device 1 (communications unit 140) and the telecommunications terminal 8 may communicate with each other both wirelessly and via cables. In that case, for example, a video signal may be transmitted via cables from the camera device 1 to the telecommunications terminal 8 while a drive command and other signals may be transmitted wirelessly from the camera device 1 to the telecommunications terminal 8. Furthermore, the camera device 1 (communications unit 140) and the telecommunications terminal 8 do not have to be configured to directly communicate with each other but may also be configured to communicate with each other indirectly via another device such as a relay.

The camera device 1 according to the exemplary embodiment described above is able to expand the range of applications of the camera device 1 without changing the specification of the camera device 1 itself. However, this is only an example and should not be construed as limiting. Optionally, the specification of the camera device 1 itself may be changeable.

Furthermore, the operating unit 170 may be omitted as appropriate from the camera device 1. Even if the operating unit 170 is omitted, the camera device 1 is still operable for the user by making the detection unit 160 accept the user's operating instructions (through a tap operation) or receiving commands (such as a drive command and an image capture command) from the telecommunications terminal 8 as described above.

In the embodiment described above, the gyrosensor 130 is provided for the printed circuit board 90. However, this configuration is only an example and should not be construed as limiting. Alternatively, the gyrosensor 130 may also be provided for somewhere else in the fixed unit 20, instead of the printed circuit board 90. Still alternatively, the gyrosensor 130 may also be provided for the movable unit 10, in place of the fixed unit 20.

Also, in the embodiment described above, the detection unit 160 includes the gyrosensor, 130 as an example. However, this is only an example and should not be construed as limiting. Alternatively, the detection unit 160 may also include a triaxial acceleration sensor. Furthermore, the relative position detection unit 131 is not an essential constituent element for the camera device 1 but may be omitted as appropriate.

Furthermore, in the embodiment described above, the movable unit 10 of the camera device 1 is configured to be rotatable in the three axis directions (namely, the panning direction, the tilting direction, and the rolling direction). However, this configuration is only an example and should not be construed as limiting. The movable unit 10 of the camera device 1 only needs to be rotatable in at least two out of the three axis directions.

Even though the camera device 1 according to the embodiment described above includes the magnetic sensors 92, the magnetic sensors 92 are not essential constituent elements for the camera device 1. When provided with no magnetic sensors 92, the camera device 1 may obtain, based on the result of detection by the gyrosensor 130, an angle of rotation for making correction to the displacement of the image capturing unit 3, for example.

Also, in the embodiment described above, the sphere 46 is configured to be fitted and fixed into the through hole 451 of the loosely fitting member 45. However, this configuration is only an example and should not be construed as limiting. Alternatively, the sphere 46 may also be configured to be fixed into the recess 506 of the loosely fitting member 502. In that case, an inner peripheral surface of the through hole 451 of the loosely fitting member 45 corresponds to the first loosely fitting surface and the raised spherical surface of the sphere 46 protruding from the loosely fitting member 502 corresponds to the second loosely fitting surface. The raised spherical surface (second loosely fitting surface) of the sphere 46 protruding from the loosely fitting member 502 is loosely fitted into the loosely fitting member 45 such that a narrow gap is left between the raised spherical surface (second loosely fitting surface) of the sphere 46 and the inner peripheral surface (first loosely fitting surface) of the through hole 451 of the loosely fitting member 45.

Furthermore, in the embodiment described above, the movable unit 10 is pivotally supported by the coupling member 50 of the fixed unit 20 so as to make the movable unit 10 rotatable. However, this is not the only configuration that allows the fixed unit 20 to hold the movable unit 10 such that the movable unit 10 is rotatable (movable). Alternatively, the movable unit 10 may also have a raised partially spherical surface and may be supported rotatably by the fixed unit 20 having a recess in which at least part of the movable unit 10 is loosely fitted. In that case, the raised partially spherical surface of the movable unit 10 and the recess of the fixed unit 20 make a point or line contact with each other to allow the movable unit 10 to rotate around the center of the raised partially spherical surface. As such a structure allowing the fixed unit 20 to hold the movable unit 10, the structure described in WO 2013/168391 A1, for example, may be adopted.

Note that the drawings referred to in the foregoing description of the exemplary embodiment (including variations thereof) are just schematic representations for use to illustrate an example of the camera device 1. Thus, the shapes, dimensions, and relative positions of the respective members illustrated on those drawings may be somewhat different from actual ones.

(6) Resume

As can be seen from the foregoing description, a camera device (1) according to a first aspect includes an image capturing unit (3), a movable unit (10), a fixed unit (20), a driving unit (30), a detection unit (160), a driving control unit (111), and a communications unit (140). The camera device (1) further includes a first interface (181), a second interface (182), and a third interface (183). The image capturing unit (3) includes an image sensor (3a). The movable unit (10) holds the image capturing unit (3) thereon. The fixed unit (20) holds the movable unit (10) in such a manner as to make the movable unit (10) movable. The driving unit (30) drives the movable unit (10) such that the movable unit (10) moves relative to the fixed unit (20). The detection unit (160) detects motion of at least one of the fixed unit (20) or the movable unit (10). The driving control unit (111) controls the driving unit (30) based on a result of detection by the detection unit (160). The communications unit (140) has the capability of communicating with a telecommunications terminal (8). The first interface (181) outputs a video signal generated by the image capturing unit (3). The second interface (182) transmits the result of detection by the detection unit (160) to the telecommunications terminal (8) via the communications unit (140). The third interface (183) receives a drive command to have the driving unit (30) controlled by the driving control unit (111) from the telecommunications terminal (8) via the communications unit (140).

This aspect allows desired functions to be performed by making the camera device (1) operate in conjunction with the telecommunications terminal (8), thus contributing to expanding the range of applications of the camera device (1) even without changing the specifications of the camera device (1) itself. That is to say, this camera device (1) makes the result of detection by the detection unit (160) for use to control the driving unit (30) available to the telecommunications terminal (8) by transmitting the result of detection by the detection unit (160) to the telecommunications terminal (8) via the second interface (182). In addition, this camera device (1) also allows the telecommunications terminal (8) to control the driving unit (30) by receiving the drive command to control the driving unit (30) from the telecommunications terminal (8) via the third interface (183). This allows the camera device (1) to perform, even without changing the specifications of the camera device (1) itself, a variety of optional functions by entering various additional functions into the camera device (1) after its specification have been fixed, thus expanding the range of applications of the camera device (1).

A camera device (1) according to a second aspect, which may be implemented in conjunction with the first aspect, further includes an image capturing control unit (150) and a fourth interface (184). The image capturing control unit (150) controls the image capturing unit (3). The fourth interface (184) receives an image capture command to have the image capturing unit (3) controlled by the image capturing control unit (150) from the telecommunications terminal (8) via the communications unit (140). This aspect allows the telecommunications terminal (8) to control the image capturing unit (3) by having the image capture command to control the image capturing unit (3) received from the telecommunications terminal (8) via the fourth interface (184). This allows a wider variety of optional functions to be added to the camera device (1) even after its specifications have been fixed, thus further expanding the range of applications of the camera device (1).

In a camera device (1) according to a third aspect, which may be implemented in conjunction with the first or second aspect, the first interface (181) is configured to transmit the video signal to the telecommunications terminal (8) via the communications unit (140). This aspect allows the video shot by the image capturing unit (3) to be displayed on a monitor (display) of the telecommunications terminal (8) or stored in the telecommunications terminal (8). This allows a wider variety of optional functions to be added to the camera device (1) even after its specifications have been fixed, thus further expanding the range of applications of the camera device (1).

In a camera device (1) according to a fourth aspect, which may be implemented in conjunction with any one of the first to third aspects, the movable unit (10) is configured to be movable, relative to the fixed unit (20), in at least two directions selected from the group consisting of a panning direction, a tilting direction, and a rolling direction. This aspect allows the movable unit (10) to move in multiple directions, and therefore, allows a wider variety of optional functions to be added to the camera device (1) even after its specifications have been fixed, thus further expanding the range of applications of the camera device (1).

In a camera device (1) according to a fifth aspect, which may be implemented in conjunction with any one of the first to fourth aspects, the driving control unit (111) is configured to drive the movable unit (10) in such a direction as to reduce vibrations of the image capturing unit (3) by controlling the driving unit (30) based on the result of detection by the detection unit (160). This aspect compensates for the shake of the image capturing unit (3), thus providing a camera device (1) with a stabilizer for reducing unwanted vibrations of the image capturing unit (3).

In a camera device (1) according to a sixth aspect, which may be implemented in conjunction with any one of the first to fifth aspects, the detection unit (160) includes a gyrosensor (130) to detect at least one of an angular velocity of the fixed unit (20) or an angular velocity of the movable unit (10). This aspect makes the output of the gyrosensor (130) available to the telecommunications terminal (8) by transmitting the output of the gyrosensor (130) to the telecommunications terminal (8) via the second interface (182) while using the output of the gyrosensor (130) to control the driving unit (30). This allows a wider variety of optional functions to be added to the camera device (1) even after its specifications have been fixed, thus further expanding the range of applications of the camera device (1).

In a camera device (1) according to a seventh aspect, which may be implemented in conjunction with any one of the first to sixth aspects, the detection unit (160) includes a relative position detection unit (131) configured to detect a relative position of the movable unit (10) with respect to the fixed unit (20). This aspect makes the output of the relative position detection unit (131) available to the telecommunications terminal (8) by transmitting the output of the relative position detection unit (131) to the telecommunications terminal (8) via the second interface (182) while using the output of the relative position detection unit (131) to control the driving unit (30). This allows a wider variety of optional functions to be added to the camera device (1) even after its specifications have been fixed, thus further expanding the range of applications of the camera device (1).

A camera system (100, 100A, 100B) according to an eighth aspect includes: the camera device (1) according to any one of the first to seventh aspects; and the telecommunications terminal (8). The telecommunications terminal (8) is configured to operate in conjunction with the camera device (1) by performing, through communication with the camera device (1), at least one of detection processing based on the result of detection by the detection unit (160) or generation processing of generating the drive command. This aspect allows desired functions to be performed by making the camera device (1) operate in conjunction with the telecommunications terminal (8), thus contributing to expanding the range of applications of the camera device (1) even without changing the specifications of the camera device (1) itself.

A program according to a ninth aspect is designed to make a computer system having the capability of communicating with the camera device (1) according to any one of the first to seventh aspects function as an acquisition unit (821) and a command giving unit (822). The acquisition unit (821) acquires the result of detection by the detection unit (160) from the second interface (182). The command giving unit (822) gives the drive command to the third interface (183). This aspect allows desired functions to be performed by making the camera device (1) operate in conjunction with the telecommunications terminal (8), thus contributing to expanding the range of applications of the camera device (1) even without changing the specifications of the camera device (1) itself.

In the camera system (100, 100A, 100B) and the program, any of the various configurations and variations described for the camera device (1) may be used in combination as appropriate.

Note that the second through seventh aspects are not essential constituent elements of the camera device (1) but may be omitted as appropriate.

### REFERENCE SIGNS LIST

1 Camera Device
3 Image Capturing Unit
8 Telecommunications Terminal
10 Movable Unit
20 Fixed Unit
30 Driving Unit
111 Driving Control Unit
130 Gyrosensor
131 Relative Position Detection Unit
140 Communications Unit
150 Image Capturing Control Unit
160 Detection Unit
181 First Interface
182 Second Interface
183 Third Interface
184 Fourth Interface
100, 100A, 100B Camera System
821 Acquisition Unit
822 Command Giving Unit

1-9. (canceled)

10. A camera device comprising:
an image capturing unit including an optical axis and an image sensor;
a movable unit configured to hold the image capturing unit thereon;
a fixed unit configured to hold the movable unit in such a manner as to make the movable unit movable;
a driving unit configured to electromagnetically drive the movable unit such that the movable unit moves relative to the fixed unit;
a detection unit configured to detect motion of at least one of the fixed unit or the movable unit;
a driving control unit configured to control the driving unit based on a result of detection by the detection unit;
a communications unit with the capability of communicating with a telecommunications terminal;
a first interface configured to output a video signal generated by the image capturing unit;
a second interface configured to transmit the result of detection by the detection unit to the telecommunications terminal via the communications unit; and
a third interface configured to receive a drive command to have the driving unit controlled by the driving control unit from the telecommunications terminal via the communications unit,
the fixed unit including:
a loosely fitting member; and
a coil unit having a coil and a yoke around which the coil is wound,
the movable unit including:
a loosely fitting surface having a raised spherical surface to be loosely fitted into the loosely fitting member; and
a drive magnet,
the movable unit being configured to be electromagnetically driven by the coil unit and the drive magnet,
the movable unit being configured to be movable, relative to the fixed unit, in a rolling direction and at least one of a panning direction or a tilting direction,
the detection unit including a gyrosensor configured to detect at least one of an angular velocity of the fixed unit or an angular velocity of the movable unit,
the driving control unit being configured to generate:
a signal for vibration damping for use to drive the movable unit in such a direction as to reduce vibrations of the image capturing unit by controlling the driving unit based on the result of detection by the detection unit; and
a signal for controlling the driving unit in accordance with the drive command, the signal for controlling being superposed on the signal for vibration damping.

11. The camera device of claim 10, further comprising:
an image capturing g control unit configured to control the image capturing unit; and
a fourth interface configured to receive an image capture command to have the image capturing unit controlled by the image capturing control unit from the telecommunications terminal via the communications unit.

12. The camera device of claim 10, wherein
the first interface is configured to transmit the video signal to the telecommunications terminal via the communications unit.

13. The camera device of claim 10, wherein
the detection unit includes a relative position detection unit configured to detect a relative position of the movable unit with respect to the fixed unit.

14. The camera device of claim 10, wherein
the signal for controlling has a higher frequency than the signal for vibration damping.

15. The camera device of claim 10, wherein
the signal for controlling has a frequency falling within a range from 100 Hz to 8 kHz.

16. A camera system comprising:
the camera device of claim 10; and
the telecommunications terminal,
the telecommunications terminal being configured to operate in conjunction with the camera device by performing, through communication with the camera device, at least one of detection processing based on the result of detection by the detection unit or generation processing of generating the drive command.

17. The camera system of claim 16, wherein
the telecommunications terminal is configured to determine, based on a result of detection by the gyrosensor, whether or not any tap operation is performed on the camera device.

18. The camera system of claim 16, wherein
the detection unit includes an acceleration sensor, and
the telecommunications terminal is configured to determine, based on a result of detection by the acceleration sensor, whether or not any tap operation is performed on the camera device.

19. The camera system of claim 17, wherein
the camera device includes a fourth interface configured to receive an image capture command to control the image capturing unit from the telecommunications terminal via the communications unit, and
the telecommunications terminal is configured to generate the image capture command according to a number of times of the tap operation performed on the camera device and detected within a designated period of time.

20. The camera system of claim 18, wherein
the camera device includes a fourth interface configured to receive an image capture command to control the image capturing unit from the telecommunications terminal via the communications unit, and
the telecommunications terminal is configured to generate the image capture command according to a number of times of the tap operation performed on the camera device and detected within a designated period of time.

21. The camera system of claim 16, wherein
the telecommunications terminal is configured to, when any tap operation on the camera device is detected, generate the drive command to vibrate the movable unit.

22. The camera system of claim 16, wherein
the camera device includes a fourth interface configured to receive an image capture command to control the image capturing unit from the telecommunications terminal via the communications unit, and
the telecommunications terminal is configured to generate the image capture command according to a number of times of the tap operation performed on the telecommunications terminal and detected within a designated period of time.

23. The camera system of claim 16, wherein
the camera device includes a fourth interface configured to receive an image capture command to control the image capturing unit from the telecommunications terminal via the communications unit, and
the telecommunications terminal estimates, by a global positioning system, a location of a user wearing the camera device, and generates the image capture command according to the location of the user.
